(19) United States
(12) Patent Application Publication
(10) Pub. No.: US 2023/0093134 A1
(43) Pub. Date: Mar. 23, 2023

(54) PROCESS FOR TREATING A POLYAMIDE-BASED COMPOSITION

(71) Applicant: ARKEMA FRANCE, Colombes (FR)

(72) Inventors: Thierry BRIFFAUD, Serquigny (FR); Jean-Jacques FLAT, Serquigny (FR)

(73) Assignee: ARKEMA FRANCE, Colombes (FR)

(21) Appl. No.: 17/798,411

(22) PCT Filed: Feb. 9, 2021
(86) PCT No.: PCT/FR2021/050233

§ 371 Date: Aug. 9, 2022

(30) Foreign Application Priority Data
Feb. 10, 2020 (FR) 2001292

(51) Int. Cl. C08J 11/06

(52) U.S. Cl. CPC C08J 11/06; C08J 2377/06

(57) ABSTRACT

The present invention relates to a process for treating a polyamide-based composition which is intended to be recycled. More particularly, the present invention relates to a process for treating a composition, typically a powder based on untransformed polyamides during the manufacture of an object in 3D printing. The invention also relates to the use of the recycled composition.

### FIELD OF THE INVENTION

The present invention relates to a process for the treatment of a composition based on polyamides which is intended to be recycled. More particularly, the present invention relates to a process for the treatment of a composition, typically a powder based on polyamides which are not transformed during the manufacture of an object in 3D printing. The invention also relates to the use of the recycled composition in a subsequent industrial transformation.

### TECHNICAL BACKGROUND

Polyamides are produced in large amounts and have been widely used in the various fields of the chemical industry for many years. However, a part, indeed even a large amount, of polyamides used in industrial transformation processes is not transformed into final products, and they cannot be reused as is as raw material for a subsequent transformation process due to the modification in their physical and/or chemical properties. This creates a real problem of waste, whether from an economic or environmental viewpoint.

Within the meaning of the present invention, the term “transformation process” is understood to mean any type of industrial transformation of a composition based on polyamides into final products, for example by extrusion, molding, typically injection molding, or also in 3D printing.

More particularly, this problem of waste is commonly observed in the field of 3D printing using a polyamide-based powder as a manufacturing starting material, such as, for example, any process for the manufacture of parts in volume by addition or agglomeration of powder, layer by layer. The agglomeration of powders by melting (hereinafter “sintering”) is brought about by radiation, such as, for example, a laser beam (laser sintering), infrared radiation, UV radiation, or any source of electromagnetic radiation which makes it possible to melt the powder layer by layer in order to manufacture three-dimensional objects. Mention may also be made of selective sintering processes using an absorber, in particular the technologies known under the names “High Speed Sintering” (HSS) and “Multi-Jet Fusion” (MJF). In these technologies, the 3D manufacture of objects is also carried out layer by layer, using a polyamide-based powder which is melted in a controlled manner for each layer constituting the 3D object: an absorber is deposited on the layer (by means, for example, of a liquid ink in the “inkjet process”) before the exposure of the layer to electromagnetic radiation (for example infrared radiation) which brings about melting of the zones containing said absorber.

For the abovementioned sintering processes, such as laser sintering, the use of a polyamide-based powder with a molecular weight of the powder in the solid state which is preferably sufficiently low, which can be reflected by an inherent viscosity in solution generally of less than 1.50, is favored, both in order for the melting of the grains not to require too much energy and in order for the intergrain coalescence to be sufficient during the passage of the radiation, so as to obtain an object with the least possible porosity, with good mechanical properties.

The polyamide-based powder used in a sintering process of the abovementioned type generally comprises more than 90%, indeed even more than 95%, of polyamide by weight of the total powder. It has been observed that, during the manufacturing process, a large part of the powder is not used: for example, in laser sintering, approximately 85% of the powder is not targeted by the laser. The surrounding powder, that is to say the powder not affected by the radiation, remains for several hours above its crystallization temperature Tc, which can result in an increase in the molecular weight and thus in the inherent viscosity of the polyamide-based powder. Consequently, the coalescence between powder grains becomes more difficult for subsequent reuse for 3D construction employing this powder.

Consequently, the starting powder which has not been affected by the radiation at the end of the printing can often possess a higher molecular weight, namely an inherent viscosity of greater than 1.50 and most often of the order of 1.70 to 2.0. Consequently, the powder is no longer capable of producing parts of mechanical strength sufficiently by a 3D printing technology. These powders have to be discarded in order to be replaced, at least in part, by a charge of “fresh” powder, which has not been subjected to temperature variations during printing.

This increase in inherent viscosity of a composition based on polyamides which is not transformed can also be observed in other processes for the machine transformation of polyamides, which prevents their reuse as is in another industrial application which requires a composition based on polyamides as starting material, the inherent viscosity of which has to be low, namely generally less than 1.50. Mention may be made, as such, of processes for transformation by extrusion of pipes or sheets, by extrusion-blow molding of tubes, by injection molding, and also the abovementioned 3D printing processes.

There thus exists a continuous need to be able to reuse these compositions based on polyamides having a high inherent viscosity, in particular those already used in a manufacture but which have not been transformed into final products during the manufacturing process.

The object of the present invention is thus to provide a method for treating compositions based on polyamides having a high inherent viscosity, generally following a transformation process, so that they can be reused as starting materials in desired industrial applications.

More particularly, the aim of the present invention is to provide a method for treating a polyamide-based powder unused on conclusion of a 3D printing process, preferably a process of 3D printing by sintering, in order to be reused as starting material for industrial transformations, for example in an injection molding, extrusion or also 3D printing process.

### SUMMARY OF THE INVENTION

According to a first aspect, a subject matter of the present invention is a process for the treatment of a composition (C1) based on polyamides (PA) which is intended to be recycled, comprising the following successive stages:

(i) a stage of supplying a mixture comprising the composition (C1) based on polyamides (PA), a polyamide chain-cutting agent, and optionally one or more filler(s) and/or additive(s);

(ii) a stage of kneading said mixture in the molten state, whereby a composition (C2) having a targeted inherent viscosity is obtained;

(iii) a stage of recovery of the composition (C2).

In the context of the present invention, the composition (C1) can be any type of industrial compositions based on polyamides, for example powders, granules, filaments, resins, fibers, films, pipes and/or their mixtures.

Within the meaning of the present invention, the term “a composition based on polyamides” is understood to mean a composition having a polyamide matrix, which generally comprises more than 40% of polyamide by volume of the total composition.

According to a particularly advantageous embodiment, the composition (C1) based on polyamides which is intended to be recycled is a powder based on polyamides, preferably that which has not been transformed on conclusion of a process of 3D printing by sintering.

When the composition (C1) is a powder based on polyamides, it generally comprises more than 50%, indeed even more than 60%, of polyamide by weight of the total composition.

The polyamide (PA) of the invention can be chosen from a homopolyamide, a copolyamide, a copolymer having polyamide blocks and polyether blocks, or their blends. It can also be a blend of one or more polyamides and at least one other polymer. The mixtures can be obtained by dry mixing of powders or by grinding the mixture in the form of granules. In the latter case, the polyamide preferably forms the matrix and the other polymer(s) form the dispersed phase.

Generally, the starting composition (C1) has an inherent viscosity of greater than or equal to 1.50, preferably of greater than or equal to 1.60.

Advantageously, the composition (C1) is a nontransformed material remaining on conclusion of a transformation process.

The “targeted” inherent viscosity of the composition (C2) is less than or equal to 1.50, preferably less than or equal to 1.40, 1.30, 1.25, 1.20, 1.15, 1.10, 1.05, or also less than or equal to 1.00.

The inherent viscosity of the composition (C2) is typically greater than or equal to 0.80.

For example, the inherent viscosity of the composition (C2) can be between 0.80 and 1.50, preferably between 0.90 and 1.40, between 0.90 and 1.30, between 0.90 and 1.20 (limits included).

The inherent viscosity of the recovered (or “recycled”) composition (C2) is typically reduced by at least 10%, preferably by at least 20%, with respect to that of the starting composition (C1).

According to one embodiment, the inherent viscosity of the recovered composition (C2) is reduced by 0.30, preferably by 0.50, with respect to that of the starting composition (C1).

The recovered composition (C2) is typically in the form of granules.

The polyamide chain-cutting agent of the invention is a chemical agent which can react with the polyamides present in the composition which is intended to be recycled and which is capable of reducing the inherent viscosity of said composition.

The inventors have found that the use of the chain-cutting agent makes it possible to “cut” the chain of polyamides, thus making it possible to reduce the inherent viscosity of the polyamide, and also the inherent viscosity of the composition based on polyamides.

The present invention thus provides for the use of a specific chain-cutting agent to reduce the inherent viscosity of a composition based on polyamides in order to recover a composition which can be used in a subsequent transformation process.

According to one embodiment, the chain-cutting agent is chosen from water, a carboxylic acid, an amino acid and/or their mixture.

According to one embodiment, the chain-cutting agent is in the form of a solid (e.g., powder or granule) or in the form of a liquid (e.g., molten or in the form of an aqueous solution).

According to one embodiment, the chain-cutting agent is a carboxylic acid. The carboxylic acid can be chosen from monocarboxylic acids, dicarboxylic acids or metal salts of mono- or dicarboxylic acids. Preferably, the carboxylic acid is chosen from adipic acid, azelaic acid, suberic acid, sebacic acid, dodecanedioic acid and/or their mixture.

According to a preferential embodiment, the carboxylic acid is adipic acid.

According to one embodiment, stage (i) is provided with from 0.1% to 2%, preferably from 0.2% to 1.8%, for example from 0.2% to 1.0%, from 0.2% to 0.8%, by weight of carboxylic acid, with respect to the weight of the composition (C1).

The carboxylic acid employed as chain-cutting agent is to be distinguished from those which may be present in the composition (C1) as residues of polymerization monomers, which are present in trace form, generally at less than 0.1%, in the composition.

According to one embodiment, the chain-cutting agent is an amino acid. The amino acid can be chosen from aminocaproic acid, 7-aminoheptanoic acid, 11-aminoundecanoic acid, 12-aminododecanoic acid and/or their mixture.

This constitutes a particularly advantageous embodiment. This is because, surprisingly, it has been observed that the use of an amino acid in the process of the invention makes it possible to rapidly reduce the inherent viscosity of the composition based on polyamides which is intended to be recycled (namely, generally in less than 10 minutes), thus making possible their reuse as starting material in transformation processes.

It has also been observed that this reduction in the inherent viscosity is reversible, that is to say that the inherent viscosity can increase again during its subsequent use. This property is particularly valuable for reapplication of the polyamides in 3D printing, a process which requires an increase in the inherent viscosity of the starting material during its implementation.

According to one embodiment, an amino acid is chosen which corresponds to the monomer unit of the polyamide (PA) in the composition (C1) to be recycled.

For example, an 11-aminoundecanoic acid can be chosen in the process for recycling a polyamide 11. Alternatively, for example, a 12-aminododecanoic acid can be chosen in a process for recycling a polyamide 12.

According to one embodiment, the amino acid is an 11-aminoundecanoic acid.

According to one embodiment, the amino acid is a 12-aminododecanoic acid.

According to one embodiment, stage (i) is provided with from 0.1% to 10%, preferably from 0.2% to 8%, for example from 1% to 7%, by weight of amino acid, with respect to the weight of the composition (C1).

The amino acid employed as chain-cutting agent is to be distinguished from those which may be present in the composition (C1) as residues of polymerization monomers, which are present in trace form, generally at less than 0.1%, in the composition.

According to one embodiment, the chain-cutting agent is water.

According to one embodiment, stage (i) is provided with from 0.05% to 10%, preferably from 0.1% to 8%, for example from 0.5% to 7%, by weight of water, with respect to the weight of the composition (C1).

The inherent viscosity targeted for the composition recovered on conclusion of the transformation process can be easily achieved, in particular by adjusting the amount of the chain-cutting agent employed. Typically, if, during the process, the final inherent viscosity reached is too high, the amount of chain-cutting agent can be increased in increments of 10% (in relative value) without changing the amount of starting composition, until the targeted inherent viscosity is obtained. In the contrary case, if the final viscosity is too low, the amount of chain-cutting agent can be reduced in increments of 10% (in relative value) without changing the amount of starting composition, until the targeted inherent viscosity is obtained.

According to one embodiment, one or more fillers and/or additives can be introduced in stage (i) of the process of the present invention. These fillers and/or additives make it possible to improve the properties of the polyamide according to its final use and/or to improve the mechanical properties (for example the Young's modulus, the elongation at break, the impact strength) or also the esthetic properties, such as the color.

According to one embodiment, the fillers and/or the additives may already be present in the composition (C1) based on polyamides (PA) which is intended to be recycled, or also be added to the composition (C2) after the recovery stage (iii).

The conditions applied in the kneading stage (ii) are chosen in order to make possible intimate mixing of the compounds in the molten state.

According to one embodiment, a temperature greater by at least 5° C., preferably greater by at least 10° C., with respect to the melting point of the polyamide (PA), is applied in the kneading stage (ii). This temperature should generally remain below 330° C., so as to avoid thermal degradation of the composition based on polyamides according to the invention.

In the context of the present invention, the composition (C1) can comprise one or more polyamides. When the composition (C1) comprises a polyamide, the temperature applied is greater by at least 5° C., preferably greater by at least 10° C., with respect to the melting point of the polyamide. When the composition (C1) comprises several polyamides, the temperature applied is greater by at least 5° C., preferably greater by at least 10° C., with respect to the highest melting point of the polyamides.

According to one embodiment, the temperature applied in stage (ii) is greater than 200° C. and less than 330° C., preferably greater than 220° C. and less than 320° C., for example of between 220° C. and 310° C., or for example of between 230° C. and 300° C.

The stage of the recovery (iii) can be carried out with methods known to a person skilled in the art.

Typically, the stage of the recovery consists of an extrusion stage, a stage of cooling the composition in the molten state using a water-containing cooling liquid, a stage of cutting the composition in the form of granules, and a stage of separation of the cooling liquid and the cooled composition.

The cutting stage can be carried out during the cooling stage, or after the cooling stage, and before the separation stage or after the separation stage.

The process of the invention can be a batch process.

The process of the invention can preferably be a continuous process.

In order to recover a composition having an inherent viscosity of less than 1.50, for example of less than 1.40, the residence time of the mixture in stage (ii) is typically equal to or less than 10 minutes, in particular less than 5 minutes, or less than 3 minutes, indeed even less.

The process of the present invention thus makes it possible to carry out a recycling of a composition based on polyamides in a simple and very effective manner: the composition intended to be recycled is treated in less than 10 minutes, indeed even in less than 5 minutes, or 3 minutes, indeed even less, so that a composition based on polyamides which can be reused as starting material can be recovered.

The present invention thus provides a simple and effective solution for recycling a composition based on polyamides, in particular such a composition in the powder form, such as that which has not been transformed on conclusion of a 3D printing process using a powder (e.g. process of 3D printing by sintering).

According to another aspect, a subject matter of the present invention is an installation for the implementation of the process of the invention. According to one embodiment, the process of the invention is carried out by means of a “reactive” extruder (with external heating) known to a person skilled in the art. Preferably, the process is carried out in an extruder comprising two conveying screws rotating in a corotating manner.

According to another aspect, a subject matter of the present invention is a recycled composition based on polyamides, which is capable of being obtained by the process of the invention, generally having an inherent viscosity of less than or equal to 1.50, preferably of less than or equal to 1.40, 1.30, 1.25, 1.20, 1.15, 1.10, 1.05, or also less than or equal to 1.00.

The recycled composition on conclusion of the transformation process can be in the form of granules, in the form of a powder, filament, resin, fiber, films or pipe, preferably in the form of granules.

One of the advantages of the present invention is that the recycled composition on conclusion of the process according to the invention can be usable directly and/or can be easily transformed with the technologies known to a person skilled in the art.

According to another aspect, the invention relates to the use of the recycled composition based on polyamides, preferably in the form of granules, in a transformation process.

According to another aspect, the invention relates to a process of transformation by employing a recycled composition based on polyamides, preferably in the form of granules, as starting material.

The invention also relates to an article manufactured according to a process of transformation by employing a recycled composition based on polyamides as is defined above.

By way of example, the composition recovered on conclusion of the process according to the invention can be used in coatings, paints, corrosion-resistant compositions, additives for paper, electrophoresis gels, multilayer composite materials, the packaging industry, toys, the textile industry, the automotive industry and/or the electronics industry.

The present invention also relates to the use of the recycled composition based on polyamides which is obtained according to the process of the invention in a 3D printing process, preferably a process of 3D printing by sintering.

According to one embodiment, the 3D printing process is a process using a powder.

Alternatively, the 3D printing process can be other types of 3D printing process other than those using a powder. For example, mention may be made of techniques such as FDM (Fused Deposition Modeling), or else FFF (Fused Filament Fabrication), using filaments.

The present invention also relates to a manufactured article obtained by the 3D printing processes as mentioned above.

This manufactured item can be chosen from prototypes, models and parts, in particular in the automotive, nautical, aeronautical, aerospace or medical (prostheses, hearing systems, cell tissues, and the like) fields, design, housings for electronics, telephony, home automation, computing, lighting, sports or industrial appliances.

The invention will now be described in more detail.

### DETAILED DESCRIPTION

### Definition

“Inherent Viscosity”

The inherent viscosity in solution of the composition based on polyamides is preferably measured according to the standard ISO 307:2007 modified in that the solvent is m-cresol rather than sulfuric acid, in that the concentration is 0.5% by weight and in that the temperature is 20° C.

Polyamides

The nomenclature used to define polyamides is described in the standard ISO 1874-1:1992 “Plastics—Polyamide (PA) moulding and extrusion materials—Part 1: Designation”, in particular on page 3 (tables 1 and 2), and is well known to a person skilled in the art.

The composition (C1) based on polyamides which is intended to be recycled of the present invention can be provided in all its forms in any industrial application, such as powder, granules, filament, resin, fiber, films or pipe.

The composition (C1) preferably has an inherent viscosity of greater than or equal to 1.50, preferably of greater than or equal to 1.60.

The polyamide can be aliphatic, semiaromatic and cycloaliphatic.

The polyamide can be chosen from a homopolyamide, a copolyamide, a copolymer having polyamide blocks and polyether blocks, and their blends.

It can also be a blend of polyamide and of at least one other polymer, the polyamide forming the matrix and the other polymer(s) forming the dispersed phase.

Within the meaning of the invention, the term “polyamide” is understood to mean the condensation products:
of one or more amino acid monomers, such as aminocaproic acid, 7-aminoheptanoic acid, 11-aminoundecanoic acid and 12-aminododecanoic acid, or of one or more lactam monomers, such as caprolactam, enantholactam and lauryllactam;
of one or more salts or mixtures of diamine monomers, such as hexamethylenediamine, decanediamine, dodecamethylenediamine, meta-xylylenediamine, bis(p-aminocyclohexyl)methane and trimethylhexamethylenediamine, with diacids, such as isophthalic acid, terephthalic acid, adipic acid, azelaic acid, suberic acid, sebacic acid, dodecanedioic acid and tetradecanedioic acid.

The polyamide can be a copolyamide. Mention may be made of copolyamides resulting from the condensation of at least two different monomers, for example of at least two different α,ω-aminocarboxylic acids or of two different lactams or of a lactam and of an α,ω-aminocarboxylic acid with a different carbon number. Mention may also be made of copolyamides resulting from the condensation of at least one α,ω-aminocarboxylic acid (or one lactam), at least one diamine and at least one dicarboxylic acid. Mention may also be made of copolyamides resulting from the condensation of an aliphatic diamine with an aliphatic dicarboxylic acid and at least one other monomer chosen from aliphatic diamines other than the preceding one and aliphatic diacids other than the preceding one.

In the present description of polyamides, the term “monomer” should be taken with the meaning of “repeat unit”. A special case is the case where a repeat unit of the polyamide consists of the combination of a diacid with a diamine. It is considered that it is the combination of a diamine and of a diacid, that is to say the “diamine-diacid” pair, also referred to as “XY” pair, in equimolar amounts, which corresponds to the monomer. This is explained by the fact that, individually, the diacid or the diamine is only a structural unit, which is not sufficient by itself alone to form a polymer.

Mention may be made, by way of example of diamine X, of aliphatic diamines having from 6 to 12 atoms, it also being possible for the diamine X to be aryl and/or saturated cyclic. Mention may be made, by way of examples, of hexamethylenediamine, piperazine, tetramethylenediamine, octamethylenediamine, decamethylenediamine, dodecamethylenediamine, 1,5-diaminohexane, 2,2,4-trimethyl-1,6-diaminohexane, polyol diamines, isophoronediamine (IPD), methylpentamethylenediamine (MPMD), bis(aminocyclohexyl)methane (BACM), bis(3-methyl-4-aminocyclohexyl)methane (BMACM), meta-xylylenediamine, bis(p-aminocyclohexyl)methane and trimethylhexamethylenediamine.

Mention may be made, by way of example of diacid (or dicarboxylic acid) Y, of acids having between 4 and 18 carbon atoms. Mention may be made, for example, of adipic acid, sebacic acid, azelaic acid, suberic acid, dodecanedioic acid, tetradecanedioic acid, isophthalic acid, butanedioic acid, 1,4-cyclohexanedicarboxylic acid, terephthalic acid, the sodium or lithium salt of 5-sulfoisophthalic acid or dimerized fatty acids (these dimerized fatty acids have a dimer content of at least 98% and are preferably hydrogenated).

The lactam or amino acid monomers are said to be of “Z” type.

Mention may be made, by way of example of lactams, of those having from 3 to 12 carbon atoms on the main ring and which can be substituted. Mention may be made, for example, of β,β-dimethylpropiolactam, α,α-dimethylpropiolactam, amylolactam, caprolactam, capryllactam, enantholactam, 2-pyrrolidone and lauryllactam.

Mention may be made, by way of example of amino acid, of α,ω-amino acids, such as aminocaproic acid, 7-aminoheptanoic acid, 11-aminoundecanoic acid, n-heptyl-11-aminoundecanoic acid and 12-aminododecanoic acid.

According to one embodiment, the polyamide (PA) according to the invention comprises at least one polyamide or one polyamide block chosen from polyamides and copolyamides comprising at least one of the following monomers: 46, 4T, 54, 59, 510, 512, 513, 514, 516, 518, 536, 6, 64, 66, 69, 610, 612, 613, 614, 616, 618, 636, 6T, 9, 104, 109, 1010, 1012, 1013, 1014, 1016, 1018, 1036, 10T, 11, 12, 124, 129, 1210, 1212, 1213, 1214, 1216, 1218, 1236, 12T, MXD6, MXD10, MXD12, MXD14, and their blends.

Preferably, the polyamides (PA) comprise at least one polyamide chosen from polyamides and copolyamides comprising at least one of the following XY or Z monomers: 59, 510, 512, 514, 6, 69, 610, 612, 614, 109, 1010, 1012, 1014, 10T, 11, 12, 129, 1210, 1212, 1214, 12T, MXD6, MXD10, MXD12, MXD14, and their blends, in particular chosen from PA 11, PA 12, PA 1010, PA 6, PA 612, and their blends.

Mention may be made, by way of examples of copolyamides, of PA 6/12, PA 6/66, PA 6/12/66, PA 6/69/11/12, PA 6/66/11/12, PA 69/12 or PA 11/10T.

It would not be departing from the scope of the invention to replace a portion of the polyamide with a copolymer having polyamide blocks and polyether blocks, that is to say to use a blend comprising at least one of the preceding polyamides and at least one copolymer having polyamide blocks and polyether blocks.

The copolymers having polyamide blocks and polyether blocks result from the copolycondensation of polyamide blocks having reactive ends with polyether blocks having reactive ends, such as, inter alia:

1) polyamide blocks having diamine chain ends with polyoxyalkylene blocks having dicarboxyl chain ends;

2) polyamide blocks having dicarboxyl chain ends with polyoxyalkylene blocks having diamine chain ends obtained by cyanoethylation and hydrogenation of α,ω-dihydroxylated aliphatic polyoxyalkylene blocks known as polyether diols;

3) polyamide blocks having dicarboxyl chain ends with polyether diols, the products obtained being, in this specific case, polyetheresteramides. These copolymers are advantageously used.

The polyamide blocks having dicarboxyl chain ends originate, for example, from the condensation of amino acids, lactams or dicarboxylic acids and diamines in the presence of a chain-limiting dicarboxylic acid. The amino acids, the lactams, the diacids and the diamines are those described above.

The polyether can, for example, be a polytetramethylene glycol (PTMG). The latter is also known as polytetrahydrofuran (PTHF).

The number-average molar mass of the polyamide blocks is between 300 and 15 000 and preferably between 600 and 5000 g/mol. The molar mass of the polyether blocks is between 100 and 6000 and preferably between 200 and 3000 g/mol.

The polymers having polyamide blocks and polyether blocks are generally prepared by the simultaneous reaction of the polyether and of the precursors of the polyamide blocks.

For example, polyether diol, a lactam (or an α,ω-amino acid) and a chain-limiting diacid can be reacted in the presence of a small amount of water. A polymer is obtained having essentially polyether blocks and polyamide blocks of very variable length, but also the various reactants which have reacted randomly, which are distributed randomly along the polymer chain.

The polyetherdiol blocks are either used as is and copolycondensed with polyamide blocks having carboxyl ends, or they are aminated in order to be converted into polyetherdiamines and condensed with polyamide blocks having carboxyl ends. They can also be mixed with polyamide precursors and a chain limiter in order to make polymers having polyamide blocks and polyether blocks which have randomly distributed units.

The ratio of the amount of copolymer having polyamide blocks and polyether blocks to the amount of polyamide is advantageously between 1/99 and 15/85 by weight.

As regards the blend of polyamide and of at least one other polymer, it is provided in the form of a blend having a polyamide matrix and the other polymer(s) form(s) the dispersed phase. Mention may be made, as examples of this other polymer, of polyolefins, polyesters, polycarbonate, PPO (abbreviation for polyphenylene oxide), PPS (abbreviation for polyphenylene sulfide) or elastomers.

The polyamide, whether or not as a blend with at least one other polymer, can contain fillers, pigments, antioxidants and UV stabilizers.

Advantageously, the composition (C1) based on polyamides which is intended to be recycled is in a divided form, such as powder or granules.

According to one embodiment, the composition (C1) based on polyamides is a polyamide-based powder intended for 3D printing, in particular in a sintering process. Preferably, the polyamide results from hydrolytic polycondensation. Hydrolytic polycondensation is induced by water at high temperature. For example, the hydrolytic polycondensation of lactams consists in opening the lactam with water and then in heating under pressure in order to polymerize. Optionally, a catalyst, such as phosphoric acid, can also be employed in the hydrolytic process.

Fillers and Additives

The composition (C1) intended to be recycled can comprise fillers. Preferably, these fillers are in the form of a powder or of granules. These fillers can already be present in the composition (C1) before the treatment process according to the invention or be added during the treatment process according to the invention, in order to contribute the mechanical properties (for example modulus, elongation at break, impact strength) to the composition recovered on conclusion of the process. Mention may be made, as examples of pulverulent fillers, of carbonate-comprising inorganic fillers, in particular calcium carbonate, magnesium carbonate, dolomite or calcite, barium sulfate, calcium sulfate, dolomite, alumina hydrate, wollastonite, montmorillonite, zeolite, perlite, nanofillers (fillers of the order of a nanometer), such as nanoclays or carbon nanotubes, glass fibers or carbon fibers.

The composition (C1) intended to be recycled can also comprise additives. Mention may be made, as examples of additives, of flow agents (e.g. silica), dyes, pigments for coloring, TiO₂, pigments for infrared absorption, fireproofing additives, antioxidants, light stabilizers, UV stabilizers, plasticizers, impact modifiers, antistatic agents, flame retardants and their mixtures. Preferably, these additives can be in the form of a powder or of granules.

Process

Use may be made, as installation for carrying out the process of the invention, of any device for the compounding, kneading or extrusion of molten plastics which is known to a person skilled in the art.

Mention may be made, by way of examples, of internal mixers, open mills, single-screw or counterrotating or corotating twin-screw extruders, continuous co-kneaders or stirred reactors. The kneading device can be one of the abovementioned appliances or their combination, such as, for example, a co-kneader in combination with a take-up single-screw, a corotating twin-screw in combination with a gear pump, a reactor connected to an extruder, and the like. The extrusion appliance is generally configured so as to identify a zone of melting of the polymer, a zone of blending and reaction between the entities present and a zone of pressure reduction/venting to remove the volatile compounds. These different zones can be given material form by the configuration of the screw of the appliance, the use of a restriction zone or the coupling together of appliances. The device can additionally be equipped with a filtration system, which is preferably continuous, and with a strand or underwater granulation system appropriate to the rheology of the polyamide.

Mention may be made, by way of example, of the Werner 30 or Coperion ZSK30 extruder. Alternatively, use may be made of any suitable kneader, such as a Brabender or Plastograph W50EHT kneader, consisting of a motor, a kneading chamber, two rotors rotating in opposite directions at different speeds to ensure kneading of the material in the molten state, a thermocouple, and data acquisition.

Preferably, the kneading stage (ii) of the process according to the invention is carried out in an intermeshing corotating twin-screw extruder, which exhibits numerous advantages. For example, the intermeshing corotating twin-screw extruder makes it possible to carry out the process continuously and with a short residence time. Furthermore, the products are less subject to thermal oxidation and in particular are less likely to undergo yellowing.

The stage of the recovery (iii) consists generally of an extrusion stage, a stage of cooling the composition in the molten state using a water-containing cooling liquid, a stage of cutting the composition in the form of granules, and a stage of separation of the cooling liquid and the cooled composition.

The extrusion stage can be carried out in a conventional way, in particular through a die. The die is generally placed at the outlet of the reactor containing the mixture, or at the outlet of a transfer line fed with molten composition using a pump, or at the outlet of a kneading device which can generate a pressure greater than atmospheric pressure, generally an extruder. At the die outlet, a material is obtained generally in the form of rods or strips, or directly in the form of granules in the case, for example, of underwater pelletizing, as explained later in the description.

The cooling stage consists in cooling the material obtained after extrusion, by contact with a water-containing cooling liquid. It can, for example, comprise an alcohol such as ethanol, isopropanol or butanol. Preferably, the cooling liquid comprises only water.

Suitable cooling devices for such a stage are known to a person skilled in the art, for example a water-spraying device located in the proximity of the device of the die plate or a bath or a stream of water located in the proximity of or in contact with the device of the die plate into which the extruded material is introduced.

The cutting stage can be carried out in suitable devices known to a person skilled in the art, for example a milling cutter system with teeth or a system comprising knives and a knife block. The device generally comprises a motor for driving the milling cutter or the knife block. The cutting device is usually rotary.

According to one embodiment, the cutting stage is carried out after the cooling stage and the stage of separation of the cooling liquid. In this case, the cooling liquid, generally water, is separated from the rods or strips of the composition and then the rods or strips are “dry” cut. The separation can be carried out, for example, by departure of the rods or strips from the bath via an entrainment device. The cooling liquid can be removed by using gravity or by sucking the liquid through a screen or any other openwork device over which the rods or strips move. These devices are known to a person skilled in the art.

According to one embodiment, the cutting and cooling stages start simultaneously. According to this embodiment, the two stages are advantageously carried out using a cutting device positioned immediately at the outlet of the die. Such a granulation device is known to a person skilled in the art. It comprises at least one cutting device which faces the die plate through which the polymer is extruded, and a cooling device. The cutting device generally comprises knives, a knife block and a motor for driving the knife block. The knife block is usually rotary. The cooling device can consist of a device for the spraying or circulation of cooling liquid located in the proximity of the device of the die plate. This is the case with “pelletizing” granulators known to a person skilled in the art. The cutting device and the die plate can also be positioned in a chamber filled with cooling liquid; in this case, it is an “underwater pelletizing” granulator. In this chamber filled with cooling liquid, the cooling liquid is generally in circulation and it provides the cooling and the transportation of the granules of compositions formed at the cutting device toward a separator, where the separation stage is carried out. The separation can be carried out using a centrifuge which separates the cooling liquid and the granules or, for example, using a cycloning device.

The process of the invention can be followed by a grinding stage in order to obtain the composition (C2) in the form of granules, flakes or coarse powders. According to one embodiment, the process according to the invention comprises a grinding stage where the composition (C2) is ground in order to obtain a composition in the form of granules, flakes or coarse powders.

The grinding stage can be carried out in a pin mill, a hammer mill or a whirl mill.

The process can additionally comprise a sieving stage. The sieving can be carried out on a sieve.

Alternatively, after grinding, the process can comprise a selection stage in order to obtain the desired particle size profile. Typically, the powders can be dispersed by a selection wheel and transported by classification air. The dust entrained in the air is conveyed through a support wheel and discharged via a first outlet. The coarse product is rejected by a classifying wheel and transported to a second outlet. The selector can comprise several successive wheels working in parallel.

According to a specific embodiment, the composition (C2) is ground, sieved and/or selected in order to obtain a powder with a volume-median diameter (D50) within the range from 5 to 200 μm, preferably in the form of a powder with a D50 within the range from 10 to 150 μm. These powders can be used as starting material in a 3D printing process using powders (e.g., 3D printing by sintering).

The invention will be further explained in a nonlimiting way with the help of the Examples which follow.

### Examples

For each example, the starting materials listed in table 1, including the PA11 powder with an inherent viscosity of 1.94, dried to a moisture content of 0.05%, are introduced under flushing with nitrogen into a Micro15 microcompounder of the DSM brand, preheated to 260° C. The speed of the screws is 100 rpm and the extruder is placed in recirculation mode for the 3 minutes corresponding to the duration of the test. Throughout the test, an estimative monitoring of the melt viscosity of the material can be carried out by measuring the Normal Force (NF). This normal force increases as the inherent viscosity and the melt viscosity increase. Samples are withdrawn at chosen intervals and their inherent viscosity is evaluated (Table 1).

TABLE 1

| Example | 1 | 2 | 3 | 4 | 5 | 6 | 7 |
|---|---|---|---|---|---|---|---|
| PA11 powder | 18 g | 17.91 g | 17.82 g | 17.1 g | 17.64 g | 17.1 g | 17.1 g |
| 11- | — | — | — | — | 0.36 g | 0.9 g | — |
| Aminoundecanoic | | | | | | | |
| acid | | | | | | | |
| Adipic acid | — | — | — | — | — | — | 0.09 g |
| Distilled water | — | 0.09 g | 0.18 g | 0.9 g | — | — | — |
| Result | Negative— | Drop in | Drop in | Drop in | Drop in | Drop in | Drop in |
| | the screws | NF | NF | NF | NF | NF | NF |
| | lock | | | | | | |
| | (excessively | | | | | | |
| | high NF) | | | | | | |
| NF minimum | — | 3 | 3 | 3 | 3 | 3 | — |
| (min) | | | | | | | |
| NF after 3 min | — | 1100 | 1000 | 1000 | 700 | 400 | 600 |
| (N) | | | | | | | |
| Inherent viscosity | — | 1.20 | 1.18 | 1.17 | 1.07 | 0.99 | 1.04 |
| after 3 min (at the | | | | | | | |
| NF minimum) | | | | | | | |

In the absence of any additive (example 1), it is not possible to melt the PA11 powder. Due to its excessively high inherent viscosity, the Force required to set the screws in motion is too high and the screws automatically lock to prevent damage to the machine.

On adding water to the PA11 powder (examples 2 to 4), it is observed that melting becomes possible and that the Normal Force decreases. This phenomenon is accompanied by a drop in the inherent viscosity. At a minimum, a PA with an inherent viscosity of less than 1.20 is easily achieved.

On adding an aminocarboxylic acid (examples 5 and 6), a drop in the Normal Force and in the inherent viscosity is observed. At a minimum, a PA11 with an inherent viscosity of less than 1.1 is easily achieved, and even than 1.0 if the content of 11-aminoundecanoic acid is adjusted.

On adding a carboxylic acid (example 7), a drop in the Normal Force and in the inherent viscosity, with an inherent viscosity of less than 1.10 being easily obtained, is observed.

Thus, an inherent viscosity of less than 1.50 can be easily achieved by employing the chain-cutting agent.

The tests were carried out under the same conditions for a period of time of 10 minutes. The results were measured (Table 2). A drop in viscosity after 3 minutes, as observed in Table 1, and then a rise in viscosity in the cases of examples 2 to 6 and a steady drop for example 7 are observed.

TABLE 2

| Example | 1 | 2 | 3 | 4 | 5 | 6 | 7 |
|---|---|---|---|---|---|---|---|
| NF after 10 | — | 2700 | 3200 | 3500 | 2000 | 1500 | 500 |
| min (N) | | | | | | | |
| Inherent | — | 1.72 | 1.85 | 1.95 | 1.55 | 1.35 | 1.01 |
| viscosity | | | | | | | |
| after 10 min | | | | | | | |

The examples above show that a desired inherent viscosity can be easily achieved by adjusting the chain-cutting agent employed and its amount and by controlling the reaction time. Typically, if a subsequent rise in viscosity is desired, a chain-cutting agent of the amino acid type can be chosen.

1. A process for the treatment of a composition (C1) based on polyamides which is intended to be recycled, comprising the following successive stages:
(i) a stage of supplying a mixture comprising the composition (C1) based on the polyamides, a polyamide chain-cutting agent, and optionally one or more filler(s) and/or additive(s);
(ii) a stage of kneading said mixture in the molten state, whereby a composition (C2) having a targeted inherent viscosity is obtained;
(iii) a stage of recovery of the composition (C2).

2. The process as claimed in claim 1, where the composition (C1) is a powder based on polyamides.

3. The process as claimed in claim 1, where the composition (C1) has an inherent viscosity of greater than or equal to 1.50.

4. The process as claimed in claim 1, where the inherent viscosity of the recovered composition (C2) is reduced by at least 10%, with respect to that of the composition (C1).

5. The process as claimed in claim 1, where the chain-cutting agent is chosen from water, a carboxylic acid, an amino acid and/or their mixture.

6. The process as claimed in claim 5, where the chain-cutting agent is a carboxylic acid, chosen from monocarboxylic acids, dicarboxylic acids, metal salts of mono- or dicarboxylic acids, and/or their mixture.

7. The process as claimed in claim 6, where stage (i) is provided with from 0.1% to 2%, by weight of carboxylic acid, with respect to the weight of the composition (C1).

8. The process as claimed in claim 5, where the chain-cutting agent is an amino acid chosen from aminocaproic acid, 7-aminoheptanoic acid, 11-aminoundecanoic acid, 12-aminododecanoic acid, and/or their mixture.

9. The process as claimed in claim 8, where stage (i) is provided with from 0.1% to 10%, by weight of amino acid, with respect to the weight of the composition (C1).

10. The process as claimed in claim 1, where a temperature greater by at least 5° C., with respect to the melting point of polyamides, and below 330° C., is applied in the kneading stage (ii).

11. The process as claimed in claim 1 is a batch process.

12. The process as claimed in claim 1 is a continuous process.

13. The process as claimed in claim 1, where the residence time of the mixture in stage (ii) is equal to or less than 10 minutes.

14. The process as claimed in claim 1, where the polyamide is chosen from a homopolyamide, a copolyamide, a copolymer having polyamide blocks and polyether blocks, and their blends.

15. The process as claimed in claim 14, where the polyamide comprises at least one polyamide or one polyamide block chosen from polyamides and copolyamides comprising at least one of the following monomers: 46, 4T, 54, 59, 510, 512, 513, 514, 516, 518, 536, 6, 64, 66, 69, 610, 612, 613, 614, 616, 618, 636, 6T, 9, 104, 109, 1010, 1012, 1013, 1014, 1016, 1018, 1036, 10T, 11, 12, 124, 129, 1210, 1212, 1213, 1214, 1216, 1218, 1236, 12T, MXD6, MXD10, MXD12, MXD14, and their blends.

16. A recycled composition based on polyamides, capable of being obtained by the process as claimed in claim 1, having an inherent viscosity of less than or equal to 1.50.

17. A transformation process comprising the use of the recycled composition as claimed in claim 16 in the form of granules.

18. A manufactured article obtained by the transformation process as claimed in claim 17.
